(19) United States
(12) Patent Application Publication
(10) Pub. No.: US 2005/0094937 A1
(43) Pub. Date: May 5, 2005

(54) Optical device and method for fabricating the same

(75) Inventors: Shiro Sato, Minato-ku (JP); Hiroyuki Nemoto, Minato-ku (JP)

Correspondence Address: RATNERPRESTIA, P O BOX 980, VALLEY FORGE, PA, 19482-0980, US

(73) Assignee: Nippon Sheet Glass Company Limited

(21) Appl. No.: 10/981,274

(22) Filed: Nov. 4, 2004

(30) Foreign Application Priority Data
Nov. 5, 2003 (JP) 2003-375,112

(51) Int. Cl. G02B 6/32

(52) U.S. Cl. 385/33

(57) ABSTRACT

Semi-columnar shaped convex portions are formed on external areas of respective resin lens plates. One semi-columnar shaped convex portion and two semi-columnar shaped convex portions are formed at the top surface of the bottom resin lens plate and the bottom surface of the top resin lens plate, respectively. Then, the top resin lens plate and the bottom resin lens plate are temporarily fixed by matching the one semi-columnar shaped convex portion into the area between the two semi-columnar shaped convex portions. Then, after the temporal fixing, the joints of the resin lens plates are heated and melted to form a welding portion. Then, the top and bottom resin lens plate are welded tightly via the welding portion.

### BACKGROUND OF THE INVENTION

1. Field of the Invention

This invention relates to an optical device which is made by joining a plurality of resin lens plates one another.

2. Description of the Related Art

As of now, an erecting lens array is disclosed e.g., in Japanese Patent Application Laid-open No. 11-245266. The erecting lens array is constituted from a plurality of lens plates which are arranged so as to be opposed to one another and wherein a plurality of minute spherical lenses or minute aspherical lenses are arranged on the corresponding lens plates.

FIG. 9 is a cross sectional view illustrating a conventional erecting lens array. A resin lens plates 101 are made by means of injection molding, and adhesive regions 102 are provided around the lens arrangement area of the resin lens plates 101. Adhesive agents 103 are applied at the adhesive regions 102 to join the resin lens plates 101 one another through the broadening and hardening of the adhesive agents 103 and to complete the erecting resin lens array. [Patent Document 1] Japanese Patent Application Laid-open 11-245266

As described above, [however](to be deleted), such an erecting resin lens array is fabricated by joining elements (resin lens plates) with adhesive agent. In this case, since the adhesive agent exhibit a large water absorbing property, the adhesive agent may expanded by absorbing moisture when the above-mentioned fabricating steps are carried out in high humidity atmosphere. Also, the adhesive agent may exhibit a water absorbing property to some degree while the erecting resin lens array is conveyed, stored and used. Therefore, the erecting lens array may be deformed and the strength of the joint between the resin lens plates may be lowered to deteriorate the reliability against humidity and temperature.

Since the expansion coefficient of the adhesive agent is larger than the expansion coefficient of an element material of the erecting lens array, the degree in expansion and shrinkage of the adhesive agent may differentiate from the degree in expansion and shrinkage of the joint of the erecting lens array due to the thermal environmental change, so that the erecting lens array may be deformed to deteriorate the reliability against humidity and temperature of the erecting lens array.

### SUMMERY OF THE INVENTION

It is an object of the present invention to iron out the above-described problems and to provide an optical device such as an erecting lens array which can exhibit an extreme reliability against humidity and temperature.

It is also an object to provide a method for fabricating the optical device.

In order to achieve the above-mentioned object, this invention relates to an optical device comprising a plurality of optical parts which are joined with one another at joints thereof,
wherein the joints are made of a material which generates heat by an energy supplied from an energy supplier and melts by the heat to form a welding portion, and the plurality of optical parts are welded via the welding portion.

In another aspect of the present invention, at least one of the joints are made of a material which generates heat by an energy supplied from an energy supplier and melts by the heat to form a welding portion, and the plurality of optical parts are welded via the welding portion.

In still another aspect of the present invention, at least one of the joints includes a substance which generates heat by an energy supplied from an energy supplier and melts by the heat to form a welding portion, and the plurality of optical parts are welded via said welding portion.

In a further aspect of the present invention, the optical device comprises a part to be melted by heat which is formed between the joints, wherein the heat is generated at the part by an energy supplied from an energy supplier to melt the joints and the part and thus, to form a welding portion, and the plurality of optical parts are welded via the welding portion.

In a still further aspect of the present invention, the optical device comprises a part to generate heat by an energy from an energy supplier which is formed between the joints, wherein the joints are melted by the heat generated at the part to form a welding portion, and the plurality of optical parts are welded via the welding portion.

This invention also relates to a method for fabricating the optical device and is characterized by comprising the steps of:
preparing a plurality of optical parts with joints,
supplying an energy to the joints of the plurality of optical parts so that heat is generated at the joints by the energy and melts the joints to form a welding portion, and
welding the plurality of optical parts via the welding portion.

According to the optical device and the fabricating method of optical device of the present invention, since the optical parts are welded via the welding portion formed from the joints by heat, the optical parts can be fixed tightly one another. Therefore, the reliability against humidity and temperature of the optical device can be enhanced.

### BRIEF DESCRIPTION OF THE DRAWINGS

For better understanding of the present invention, reference is made to the attached drawings, wherein

FIG. 1(a) is a plan view illustrating a resin erecting lens array according to the present invention,

FIG. 1(b) is a cross sectional view of the resin erecting lens array illustrated in FIG. 1(a), taken on line “A-A”,

FIG. 2(a) is a plan view illustrating a portion of a surface of the resin lens plate on which no light absorbing film is formed,

FIG. 2(b) is a cross sectional view of the resin lens plate illustrated in FIG. 2(a), taken on line “B-B”,

FIG. 2(c) is a plan view illustrating a portion of the surface of the resin lens plate on which a light absorbing film is formed,

FIG. 3 is a schematic view illustrating a fabricating method of resin erecting lens array by means of laser welding method,

FIG. 4 is a cross sectional view illustrating another joint state of resin lens plates of a resin erecting lens array according to the present invention,

FIG. 5 is a cross sectional view illustrating still another joint state of resin lens plates of a resin erecting lens array according to the present invention,

FIG. 6 is a cross sectional view illustrating a further joint state of resin lens plates of a resin erecting lens array according to the present invention,

FIG. 7 is a cross sectional view illustrating a still further joint state of resin lens plates of a resin erecting lens array according to the present invention,

FIG. 8 is a cross sectional view illustrating another joint state of resin lens plates of a resin erecting lens array according to the present invention, and

FIG. 9 is a cross sectional view illustrating a conventional resin erecting lens array wherein a plurality of resin lens plates are joined with adhesive agent.

### DESCRIPTION OF THE PREFERRED EMBODIMENTS

This invention will be described in detail with reference to the attaching drawings hereinafter. In this embodiment, a resin erecting lens array will be described as an optical device according to the present invention.

The resin erecting lens array can be applied for an aerial region displaying device which can display a three-dimensional or two-dimensional image, an image projecting device which can project a given image on a screen and an image transmitting device which can display a given image on a photo acceptance unit or a photosensitive substance.

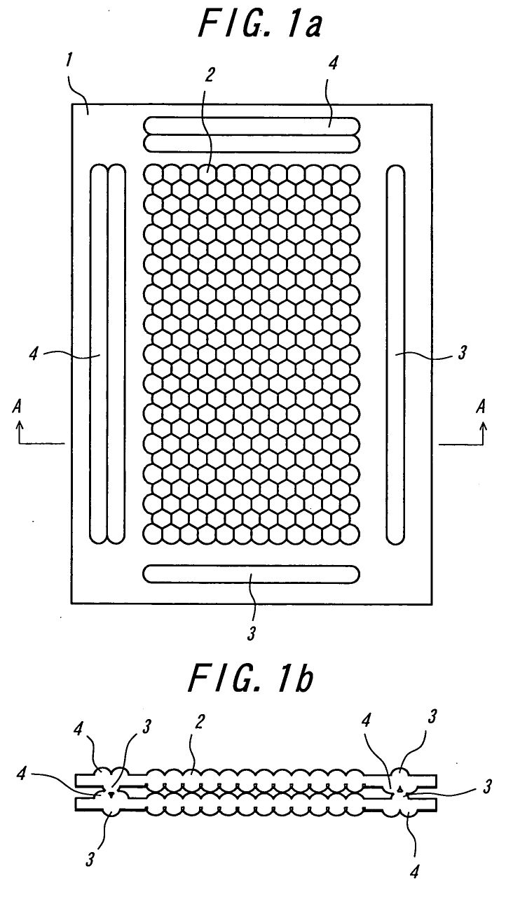

FIG. 1(a) is a plan view illustrating a resin erecting lens array according to the present invention, and FIG. 1(b) is a cross sectional view of the resin erecting lens array illustrated in FIG. 1, taken on line “A-A”.

The resin erecting lens array illustrated in FIGS. 1(a) and 1(b) includes resin lens plates 1 as optical elements which are stacked each other. Each resin lens plate 1 is formed rectangularly, and includes a lens formation region at the center thereof. Minute spherical convex lenses 2 are formed at the lens formation region so that the convex lenses 2 are arranged zigzag. Semi-columnar shaped convex portions 3 and 4 are formed at the external areas of the resin lens plates 1, and the resin lens plates 1 are welded each other by contacting the semi-columnar shaped convex portions 3 and 4.

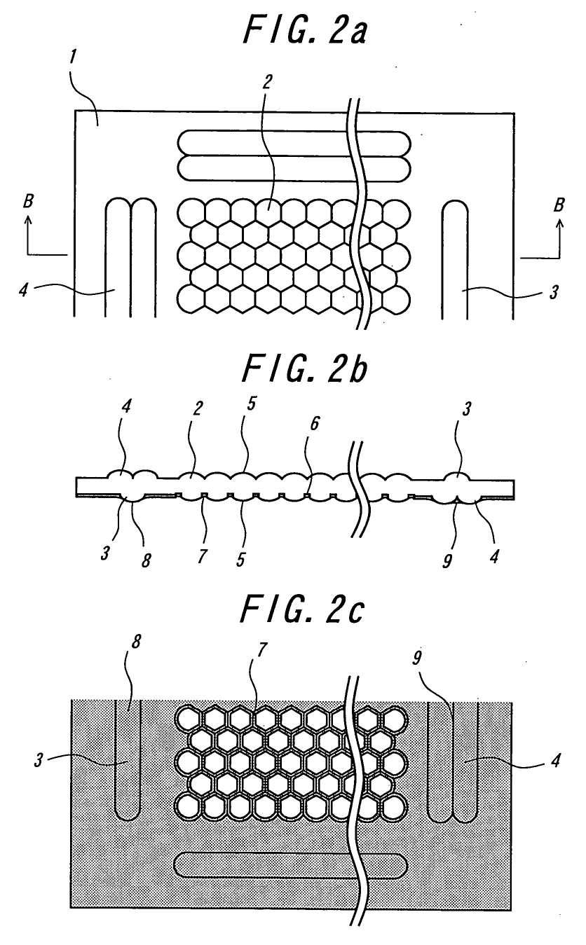

FIG. 2(a) is a plan view illustrating a portion of a surface of the resin lens plate on which no light absorbing film is formed, and FIG. 2(b) is a cross sectional view of the resin lens plate illustrated in FIG. 2(a), taken on line “B-B”, and FIG. 2(c) is a plan view illustrating a portion of the surface of the resin lens plate on which a light absorbing film is formed.

The resin lens plates 1 can be made by means of injection molding. In this point of view, it is desired that the resin material of resin lens plates are a resin material with high light transmittance and low water absorption which is usable for the injection molding. In this embodiment, the resin lens plates 1 are made from cycloolefin-based resin. The resin lens plates 1, however, may be made from another resin such as olefin-based resin and norbornane-based resin. Concretely, as the cycloolefin-based resin, the olefin-based resin and the norbornane-based resin can be exemplified “Zeonex” (registered trademark) made by Zeon Corporation, “Zeonor” (registered trademark) made by Zeon Corporation and “Arton” (registered trademark) made by JSR Corporation.

At each resin lens plate are formed one semi-columnar shaped convex portion 3 in one side in the width direction thereof and two semi-columnar shaped convex portions 4 in the other side in the width direction thereof. Moreover, at each resin lens plate are formed one semi-columnar shaped convex portion 3 in one side in the longitudinal direction thereof and two semi-columnar shaped convex portions 4 in the other side in the longitudinal direction thereof. In the stacking of the resin lens plates, the one semi-columnar shaped convex portion 3 is contacted with the concave region between the two semi-columnar shaped convex portions 4 so that the resin lens plates are fixed each other. In the fixing of the resin lens plates 1, the arrangement of minute convex lenses 2 which are formed at the resin lens plates can be fixed.

The semi-columnar shaped convex portions 3 and 4 can be formed as follow. First of all, a glass master with a circular opening pattern is prepared as described in the above-mentioned Patent Document 1. Each opening is made of a depressed portion corresponding to each minute convex spherical lens 2. That is, in the transcription using the glass master to be described later, the openings (depressed portions) are inverted to form the convex portions corresponding to the minute convex spherical lenses. The glass master includes slit-like openings corresponding the semi-columnar shaped convex portions 3 and 4 at the outer sides thereof. Etching is performed through the slit-like openings to form the convex portion corresponding to the semi-columnar shaped convex portions 3 and 4. With the etching, the width of the semi-columnar shaped convex portions 3 and 4 is larger than the width of the slit-like openings.

Then, a master block is made by transcribing the glass master onto a resin, and then, a Ni mold is made from the master block through Ni electro-typing. The intended resin lens plates 1 are made by means of injection molding using the Ni mold. In this case, the openings are transcribed onto the resin lens plates 1 to form the convex portions corresponding the minute convex spherical lenses 2 and semi-columnar shaped convex portions 3, 4 precisely.

As the result of the transcription, the minute spherical lenses 2 are formed alternately in hound's tooth check in the center lens formation regions of the resin lens plates 1. As is apparent from the drawings, the minute spherical lenses 2 are constituted from the convex portions formed at both surfaces of the corresponding resin lens plates 1. The optical axes and the positions of the minute spherical convex lenses 2 of the corresponding resin lens plates are matched one another by the position matching through transcription due to the semi-columnar shaped convex portions 3 and 4.

As is apparent from the drawings, the plane outline of each minute convex lens 2 is hexagonal, and the minute convex lenses 2 are arranged closely without space. That is, the minute convex lenses 2 can exhibit a closed packed structure.

In this embodiment, the minute spherical convex lenses 2 are employed, but minute aspherical convex lenses will do. Moreover, in this embodiment, the minute spherical convex lenses 2 are arranged in hound's tooth check, but may be in lattice such as squares so as to be along the sides of the resin lens plates. In addition, in this embodiment, the semi-columnar shaped convex portions 3 and 4 are arranged rectangularly so as to be along the sides of the resin lens plates, but may be so as to be inclined from the sides thereof.

In this embodiment, the plane outline of each minute convex lens 2 is hexagonal, but may be circular, tetragonal or any other shape in dependence on the arrangement distances of the minute convex lenses 2 and the diameters of the minute convex lenses 2. Moreover, in this embodiment, the minute convex lenses 2 are arranged closely, but may be not closely. In addition, in this embodiment, the minute convex lenses 2 are constituted from the convex portions formed at both surfaces of the resin lens plate, but may be constituted from convex portions formed at either surface of the resin lens plate.

Anti-reflective films 5 are formed on the outer surfaces of resin lens plates 1 so as to cover the minute convex lenses 2. The anti-reflective films 5 functions as to reduce the reflectivity of the resin lens plate 1 and is made of, e.g., silicon compound film with a lower refractive index than the refractive index of the resin lens plate 1. Instead of the silicon compound film, a fluorine-based resin film may be employed for the anti-reflective film 5.

Apertures 7 are formed of a light absorbing film on the anti-reflective films 5 in order to remove stray light.

The apertures 7 can be made by forming grooves 6 at the minute convex lenses 2 and forming the light absorbing film so as to cover the grooves 6. In this embodiment, the light absorbing film is made of a light absorbing paint, and is formed on one surface of the resin lens plate 1 constituting an imaging surface wherein a light is imaged as an image point from an object point (optical source) through the lenses which is located between the object point and the image point.

In this embodiment, the apertures 7 are formed on one surface of the resin lens plate 1, but may be on both surfaces of the resin lens plate 1. Moreover, after the apertures 7 are formed, the anti-reflective films 5 may be formed.

The apertures 7 can be made by forming a light absorbing film made of light reactive material such as carbon-containing black resist so as to cover the lens formation region or the entire surface region of the resin lens plate 1 and forming openings corresponding to the apertures by means of photolithography. Moreover, the apertures 7 can be made by applying a black paint and partially wiping off the black paint with a sponge to form openings corresponding to the apertures.

In the application of the light absorbing paint for forming the apertures 7, the light absorbing paint is applied on the one semi-columnar shaped convex portion 3 and the two semi-columnar shaped convex portions 4. The light absorbing paint portions applied on the semi-columnar shaped convex portions 3 and 4 are designated by numerals “8” and “9”.

Next, the stacking of the resin lens plates via the contact of the semi-columnar shaped convex portion 3 with the semi-columnar shaped convex portions 4 will be described.

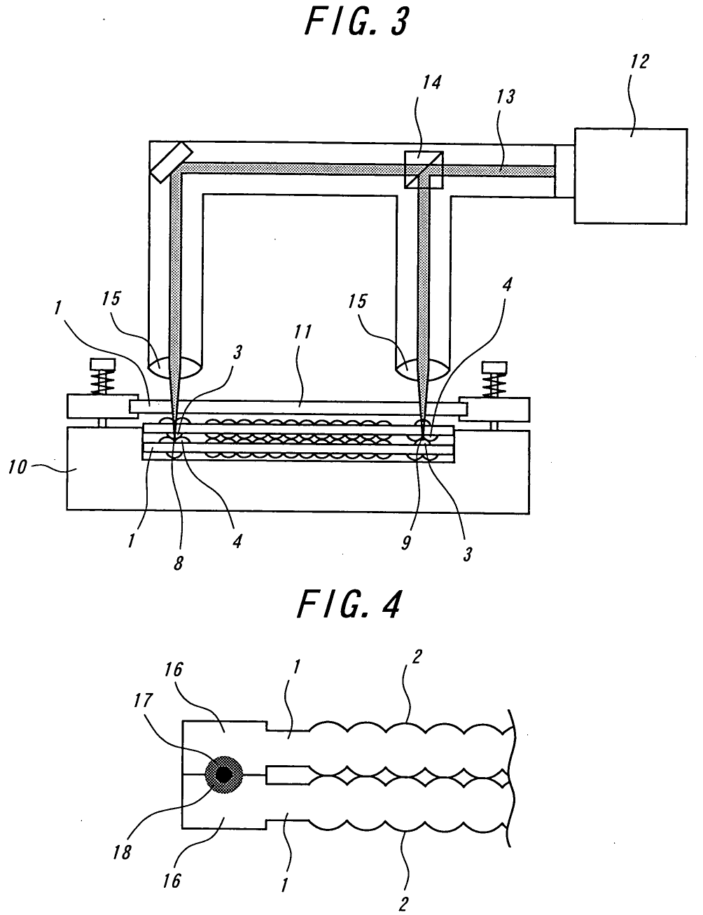

FIG. 3 is a schematic view illustrating a fabricating method of resin erecting lens array by means of laser welding method. In this case, the resin lens plates 1 are welded by means of the laser welding method.

The resin lens plates 1 are set on an assemble stage 10 so that the surface of each resin lens plate 1 wherein the apertures 7 are formed is directed downward.

Then, the semi-columnar shaped convex portions 3 and 4 of the top surface of the bottom resin lens plate 1 are matched with the semi-columnar shaped convex portions 4 and 3 of the bottom surface of the top resin lens plate 1, respectively so that the position of the bottom resin lens plate 1 is matched with the position of the top resin lens plate 1.

Then, the resin lens plates 1 are temporarily fixed by pressing the plates 1 from above with a pressing jig 11 made of quartz glass with high transmittance of laser beam. In the temporal fixing, the resin lens plates 1 are pressed each other via the semi-columnar shaped convex portions 3 and 4.

Then, a laser beam 13 with a wavelength of 840 nm is emitted from a GaAsAl semiconductor laser device 12, split at a beam splitter 14 and introduced to the resin lens plates 1 temporarily fixed with the pressing jig 11. In this way, in this embodiment, the semiconductor laser device 12 to emit the laser beam with the wavelength of 840 nm is employed, but another semiconductor laser device to emit, e.g, a laser beam with a near-infrared wavelength of 808 nm may be employed. In addition, a YAG laser to emit a laser beam with a wavelength of 1060 nm may be also employed.

The laser beam 13 is concentrated with a condenser 15 so as to be focused onto the semi-columnar shaped convex portions 3 and 4 formed at the bottom surface of the top resin lens plate 1 in view of the thickness of the semi-columnar shaped convex portions 3 and 4.

Since the light absorbing film is not formed on the top surface of the top resin lens plate 1, the concentrated laser beam 13 is incident into the top resin lens plate 1 via the top surface, irradiated and focused to the semi-columnar shaped convex portions 3 and 4 formed at the bottom surface of the top resin lens plate 1. In this case, since the light absorbing paints 8 and 9 are applied on the semi-columnar shaped convex portions 3 and 4, the light absorbing paints 8 and 9 absorb the laser beam 13 to generate heat.

The heat is transmitted to the semi-columnar shaped convex portions 3 and 4 formed at the top surface of the bottom resin lens plate 1 from the semi-columnar shaped convex portions 4 and 3, respectively to melt the semi-columnar shaped convex portions 3 and 4 formed at both of the resin lens plates 1.

Herein, since the resin lens plates 1 exhibit high light transmittance, the laser beam 13 is not absorbed in the resin lens plates 1 so that the resin lens plates 1 are not thermally deformed by the laser beam 13.

As described above, in this embodiment, the resin lens plates 1 are made by means of injection molding, and welded by means of laser welding to complete the resin erecting lens array.

Moreover, in this embodiment, the semi-columnar shaped convex portions 3 and 4 are provided around the arrangement region of the minute convex lenses 2, and used to match the positions of the resin lens plates 1 and to weld the resin lens plates 1 by means of laser welding, but any other welding method can be applied and any other position matching method can be applied.

In addition, in this embodiment, the laser beam 13 is supplied to generate the heat at the light absorbing paints 8 and 9, another infrared light or ultraviolet light may be supplied to generate the heat thereat.

Next, another joint state between the resin lens plates will be described.

In the above-described embodiment, the light absorbing paints 8 and 9 are applied on the semi-columnar shaped convex portions 3 and 4, and the laser beam 13 is concentrated and focused to the convex portions 3 and 4 to generate the heat and thus, weld the resin lens plates 1 each other. That is, the convex portions 3 and 4 as a joint are welded to complete the intended resin erecting lens array.

In another aspect, a heat generating substance, which generate heat through the absorption of the energy from an energy supplier, may be inserted between the resin lens plates 1. In this case, the resin lens plates 1 are welded by the heat generated through energy absorption.

FIG. 4 is a cross sectional view illustrating this joint state wherein a heat generating substance is inserted. In FIG. 4, concretely, a metallic part 17 as the heat generating substance is inserted at the joints 16 of the resin lens plates 1. The resin around the metallic part 17 is melted by the heat generated from the metallic part 17 to form a welding portion 18. Therefore, the resin lens plates 1 are welded via the welding portion 18 to complete the intended resin erecting lens array.

The metallic part 17 can be heated by laser beam, infrared light, ultraviolet light or high frequency wave. The metallic part 17 can be also heated using metal resistance heating by flowing electric current therein.

In still another aspect, the joints of the resin lens plates 1 may be made of heat generating-welding material. In this case, the joints themselves absorb the energy from an energy supplier to generate heat which melts the joints and welds the resin lens plates 1.

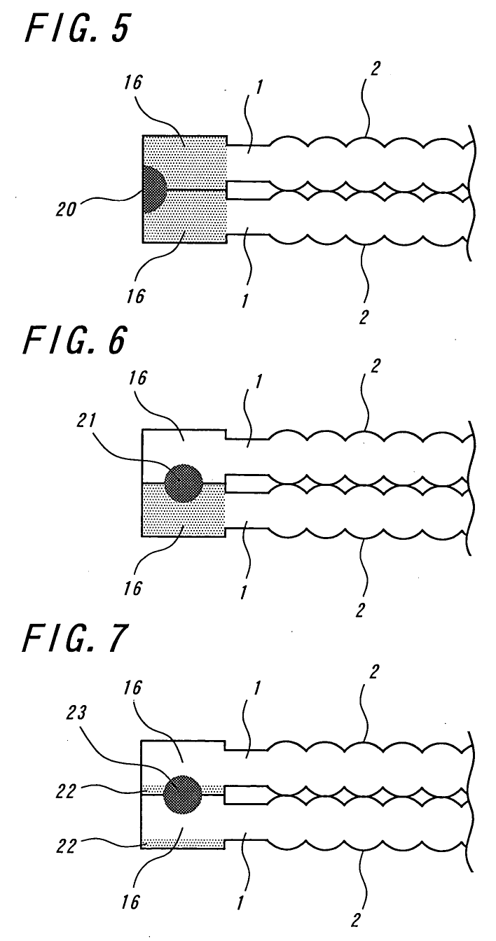

FIG. 5 is a cross sectional view illustrating still another joint state of resin lens plates of a resin erecting lens array according to the present invention, and FIG. 6 is a cross sectional view illustrating a further joint state of resin lens plates of a resin erecting lens array according to the present invention. In both cases relating to FIGS. 5 and 6, the joints of the resin lens plates 1 are made of heat generating-welding material.

In FIG. 5, the minute convex lenses 2, which are arranged in the lens arrangement region, are made of a resin with high light transmittance, and the joints 16 are made of a resin with high light absorption. Therefore, heat is generated at the joints 16 to be melted to form a welding portion 20 so that the resin lens plates 1 are welded via the welding portion 20 to complete the intended resin erecting lens array.

In FIG. 6, the minute convex lenses 2, which are arranged in the lens arrangement region, are made of a resin with high light transmittance, and the joint 16 of the top resin lens plate 1 is also made of a resin with high light transmittance. Then, the joint 16 of the bottom resin lens plate 1 is made of a resin with high light absorption. Therefore, heat is generated at the bottom joints 16 to be melted to form a welding portion 21 so that the resin lens plates 1 are welded via the welding portion 21 to complete the intended resin erecting lens array.

The resin lens plates 1 illustrated in FIGS. 5 and 6 can be formed by preparing resins with respective high light transmittance and high light absorption and injecting the resins via gates of an injection molding machine.

Also, a paint can be coated at the injection molded piece by means of in-mold coating method. FIG. 7 is a cross sectional view illustrating a still further joint state of resin lens plates of a resin erecting lens array according to the present invention. In FIG. 7, a paint is coated at the joints by means of in-mold coating method, and heat is generated at the joints to be melted to form a welding portion and thus, weld the resin lens plates via the welding portion.

Referring to FIG. 7, the resin lens plates are injection-molded and then, the mold is opened. Thereafter, the light absorbing paint is injected into the mold to form light absorbing regions 22 on the joints 16 of the resin lens plates 1. Then, the joints 16 are melted through heat absorption to form a welding portion 23 and weld the resin lens plates 1. As a result, the intended resin erecting lens array can be fabricated.

One of the light absorbing regions 22 may be formed on the corresponding joint 16 of the resin lens plate 1.

In FIGS. 5-7, as the energy can be exemplified laser beam, infrared light or ultraviolet light.

In a further aspect, a heat generating part, which generates heat through the absorption of the energy from an energy supplier, may be inserted between the resin lens plates 1. In this case, the resin lens plates 1 are welded by the heat generated through energy absorption.

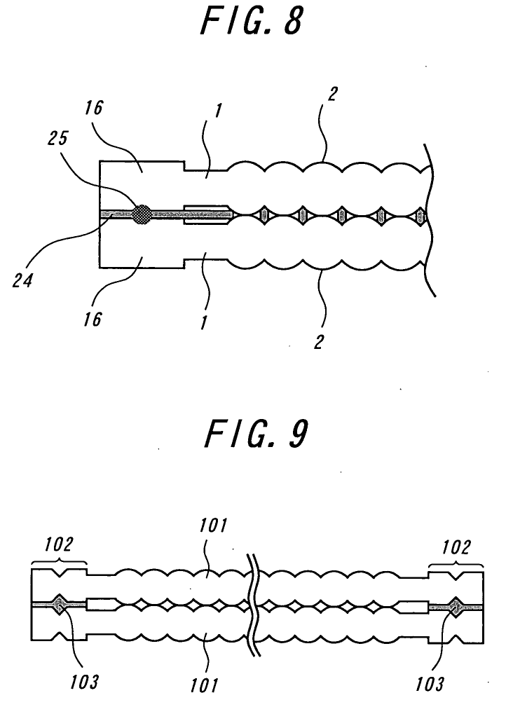

FIG. 8 is a cross sectional view illustrating this joint state wherein a heat generating part is inserted. In FIG. 8, concretely, a light shielding film 24 as the heat generating part is inserted between the joints 16 of the resin lens plates 1. The light shielding film 24 and the joints 16 are melted by the heat generated from the light shielding film 24 to form a welding portion 25. Therefore, the resin lens plates 1 are welded via the welding portion 25 to complete the intended resin erecting lens array.

The light shielding film 24 can be made by preparing a film with high light transmittance and printing light absorptive openings corresponding to the minute convex lenses pitch on the film or preparing a film with low light transmittance and forming openings corresponding to the minute convex lenses pitch through the film.

As the energy to melt and weld the joints 16 of the resin lens plates 1 and the light absorbing film 24 can be exemplified laser beam, infrared light or ultraviolet light.

In the above-described embodiment, two resin lens plates are prepared, stacked and welded, but three or more resin lens plates may be prepared, stacked and welded.

1. An optical device comprising a plurality of optical parts which are joined with one another at joints thereof,
wherein said joints are made of a material which generates heat by an energy supplied from an energy supplier and melts by said heat to form a welding portion, and said plurality of optical parts are welded via said welding portion.

2. An optical device comprising a plurality of optical parts which are joined with one another at joints thereof,
wherein at least one of said joints are made of a material which generates heat by an energy supplied from an energy supplier and melts by said heat to form a welding portion, and said plurality of optical parts are welded via said welding portion.

3. An optical device comprising a plurality of optical parts which are joined with one another at joints thereof,
wherein at least one of said joints includes a substance which generates heat by an energy supplied from an energy supplier and melts by said heat to form a welding portion, and said plurality of optical parts are welded via said welding portion.

4. An optical device comprising:
a plurality of optical parts which are joined with one another at joints thereof, and
a part to be melted by heat which is formed between said joints,
wherein said heat is generated at said part by an energy supplied from an energy supplier to melt said joints and said part and thus, to form a welding portion, and said plurality of optical parts are welded via said welding portion.

5. The optical device as defined in claim 4, wherein said part includes a light shielding film.

6. An optical device comprising:
a plurality of optical parts which are joined with one another at joints thereof, and
a part to generate heat by an energy from an energy supplier which is formed between said joints,
wherein said joints are melted by said heat generated at said part to form a welding portion, and said plurality of optical parts are welded via said welding portion.

7. The optical device as defined in claim 6, wherein said part includes a metallic part.

8. An optical device comprising:
a plurality of resin lens plates which are joined with one another at joints thereof, and
minute spherical or aspherical convex lenses which are formed at said plurality of resin lens plates by a given pitch,
wherein said joints are made of a material which generates heat by an energy supplied from an energy supplier and melts by said heat to form a welding portion, and said plurality of resin lens plates are welded via said welding portion.

9. An optical device comprising:
a plurality of resin lens plates which are joined with one another at joints thereof, and
minute spherical or aspherical convex lenses which are formed at said plurality of resin lens plates by a given pitch,
wherein at least one of said joints are made of a material which generates heat by an energy supplied from an energy supplier and melts by said heat to form a welding portion, and said plurality of resin lens plates are welded via said welding portion.

10. An optical device comprising:
a plurality of resin lens plates which are joined with one another at joints thereof, and
minute spherical or aspherical convex lenses which are formed at said plurality of resin lens plates by a given pitch,
wherein at least one of said joints includes a substance which generates heat by an energy supplied from an energy supplier and melts by said heat to form a welding portion, and said plurality of resin lens plates are welded via said welding portion.

11. The optical device as defined in claim 10, wherein said substance is a light absorptive film.

12. The optical device as defined in claim 11, wherein said convex lenses include respective apertures which are made from said light absorptive film.

13. An optical device comprising:
a plurality of resin lens plates which are joined with one another at joints thereof,
minute spherical or aspherical convex lenses which are formed at said plurality of resin lens plates by a given pitch, and
a part to be melted by heat which is formed between said joints,
wherein said heat is generated at said part by an energy supplied from an energy supplier to melt said joints and said part and thus, to form a welding portion, and said plurality of resin lens plates are welded via said welding portion.

14. The optical device as defined in claim 13, wherein said part is a light shielding film.

15. The optical device as defined in claim 14, wherein said convex lenses include respective apertures which are made from said light shielding film.

16. An optical device comprising:
a plurality of resin lens plates which are joined with one another at joints thereof,
minute spherical or aspherical convex lenses which are formed at said plurality of resin lens plates by a given pitch, and
a part to generate heat by an energy from an energy supplier which is formed between said joints,
wherein said joints are melted by said heat generated at said part to form a welding portion, and said plurality of resin lens plates are welded via said welding portion.

17. The optical device as defined in claim 16, wherein said part includes a metallic part.

18. A method for fabricating an optical device, comprising the steps of:
preparing a plurality of optical parts with joints,
supplying an energy to said joints of said plurality of optical parts so that heat is generated at said joints by said energy and melts said joints to form a welding portion, and
welding said plurality of optical parts via said welding portion.

19. A method for fabricating an optical device, comprising the steps of:
preparing a plurality of resin lens plates with joints,
forming minute spherical or aspherical convex lenses on said plurality of resin lens plates,
supplying an energy to said joints of said plurality of resin lens plates so that heat is generated at said joints by said energy and melts said joints to form a welding portion, and
welding said plurality of resin lens plates via said welding portion.

20. The fabricating method as defined in claim 18, wherein said energy includes laser beam, infrared light or ultraviolet light.

21. The fabricating method as defined in claim 19, wherein said energy includes laser beam, infrared light or ultraviolet light.
